(19) United States
(12) Patent Application Publication
(10) Pub. No.: US 2017/0356304 A1
(43) Pub. Date: Dec. 14, 2017

(54) SYSTEMS AND METHODS FOR REDUCING FLUID VISCOSITY IN A GAS TURBINE ENGINE

(71) Applicant: GENERAL ELECTRIC COMPANY, Schenectady, NY (US)

(72) Inventor: Richard Schmidt, Loveland, OH (US)

(21) Appl. No.: 15/181,070

(22) Filed: Jun. 13, 2016

(51) Int. Cl. F01D 25/10; F02C 7/06; H05B 6/06; H05B 6/10; F01D 25/04; F02C 7/224

(52) U.S. Cl. CPC F01D 25/10; F01D 25/04; F02C 7/224; H05B 6/06; H05B 6/108; F02C 7/06; F05D 2260/20; F05D 2220/32

(57) ABSTRACT

A fluid viscosity system for use in a gas turbine engine includes an induction assembly coupled to a fluid line within the gas turbine engine. The induction assembly includes an electromagnet. The induction assembly further includes an electronic oscillator electronically coupled to the electromagnet. The electronic oscillator is configured to generate an alternating current (AC) that is transmitted to the electromagnet at a predetermined frequency and magnitude such that a viscosity of a fluid channeled through the fluid line is reduced at least partially due to induction heating.

### BACKGROUND

The field of the disclosure relates generally to gas turbine engines and, more particularly, to systems and method for reducing fluid viscosity in a gas turbine engine.

Gas turbine engines typically include squeeze film dampers that provide damping to rotating components, such as a rotor shaft, to reduce and control vibration. At least some known squeeze film dampers include a bearing support member, such as an outer race of a rolling element bearing supported shaft, fitted within an annular housing chamber that restricts radial motion of the bearing support member. An annular film space is defined between an outer surface of the outer race and an opposite inner surface of the bearing housing such that damper oil can be introduced therein. Vibratory and/or radial motion of the shaft and its bearing generate hydrodynamic forces in the damper oil within the annular film space for damping purposes. The damper oil is generally provided by an oil supply system including a pump that circulates the damper oil through the annular film space.

In known squeeze film damper systems, damping is generally based on a viscosity of the damper oil, wherein colder temperature oil is generally highly viscous which is stiffer and more resistant to shear and/or tensile stress. During cold weather engine start conditions, highly viscous oil may lead to rotordynamic instability within the engine. By heating the damper oil and lowering its viscosity, engine stability is increased. Some known oil viscosity systems are external systems that include an auxiliary oil line which couples to an engine oil tank. The auxiliary oil line pumps the oil out of the oil tank to heat and then returns the oil to the oil tank. However, external systems need to be connected to the oil tank and extract the oil for the oil to be heated and reduce viscosity.

### BRIEF DESCRIPTION

In one aspect, a fluid viscosity system for use in a gas turbine engine is provided. The fluid viscosity system includes an induction assembly coupled to a fluid line within the gas turbine engine. The induction assembly includes an electromagnet. The induction assembly further includes an electronic oscillator electronically coupled to the electromagnet. The electronic oscillator is configured to generate an alternating current (AC) that is transmitted to the electromagnet at a predetermined frequency and magnitude such that a viscosity of a fluid channeled through the fluid line is reduced at least partially due to induction heating.

In another aspect, a gas turbine engine is provided. The gas turbine engine includes a damping system. A fluid line coupled in flow communication to the damping system and configured to channel an oil through the fluid line to the damping system. The gas turbine engine further includes a fluid viscosity system that includes an induction assembly coupled to the fluid line. The induction assembly includes an electromagnet. The induction assembly further includes an electronic oscillator electronically coupled to the electromagnet. The electronic oscillator is configured to generate an alternating current (AC) that is transmitted to the electromagnet at a predetermined frequency and magnitude such that a viscosity of the oil channeled through the fluid line is reduced at least partially due to induction heating.

In yet another aspect, a method for reducing fluid viscosity with a fluid viscosity system in a gas turbine engine is provided. The fluid viscosity system includes an induction assembly is coupled to a fluid line. The induction assembly includes an electromagnet and an electronic oscillator electronically coupled to the electromagnet. The method includes channeling a flow of fluid through the fluid line, and inducing an alternating current (AC) by the electronic oscillator. The method further includes transmitting to the electromagnet the AC at a predetermined frequency and magnitude such that a viscosity of the fluid channeled through the fluid line is reduced at least partially due to induction heating.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary gas turbine engine in accordance with an example embodiment of the present disclosure.

FIG. 2 is a schematic illustration of an exemplary fluid viscosity system from the turbofan engine shown in FIG. 1.

FIG. 3 is a perspective view of an exemplary metallic fluid line section that may be used with the fluid viscosity system shown in FIG. 2.

FIG. 4 is a flow diagram of an exemplary embodiment of a method for reducing fluid viscosity with a fluid viscosity system, such as the fluid viscosity system shown in FIGS. 1 and 2, in a gas turbine engine.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Embodiments of a fluid viscosity system as described herein provide a system and method that facilitates reducing gas turbine engine fluid viscosity within a gas turbine engine. Specifically, the fluid viscosity system includes an induction assembly coupled to a fluid line which applies an alternating current (AC) at a predetermined frequency and magnitude such that a fluid channeled through the fluid line is heated to a predetermined temperature through induction heating reducing viscosity thereof. In some embodiments, a temperature sensor is coupled in flow communication with the fluid line such that a temperature of the fluid channeled through the fluid line is measured for controlling the AC generated by the induction assembly. By heating the fluid within the fluid line and reducing viscosity, fluid viscosity system may be placed anywhere along the fluid line while also increasing control over the fluid temperature. Additionally, the fluid is directly channeled to a gas turbine engine component increasing efficiency of the fluid viscosity system and reducing energy consumption. Fluid viscosity system further decreases engine weight such that overall engine efficiency is increased.

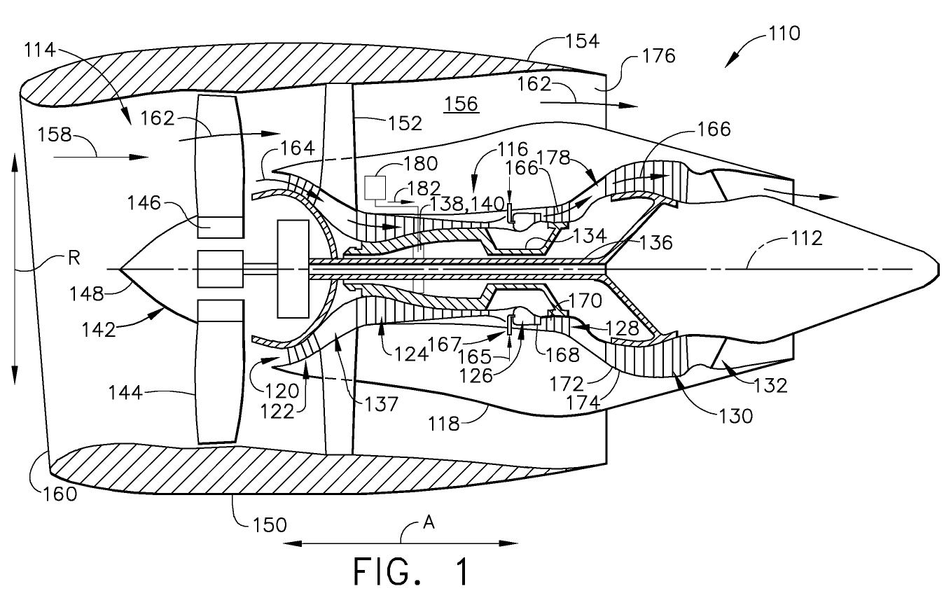

FIG. 1 is a schematic cross-sectional view of a gas turbine engine in accordance with an exemplary embodiment of the present disclosure. In the exemplary embodiment, the gas turbine engine is a high-bypass turbofan jet engine 110, referred to herein as “turbofan engine 110.” As shown in FIG. 1, turbofan engine 110 defines an axial direction A (extending parallel to a longitudinal centerline 112 provided for reference) and a radial direction R (extending perpendicular to longitudinal centerline 112). In general, turbofan engine 110 includes a fan case assembly 114 and a gas turbine engine 116 disposed downstream from fan case assembly 114.

Gas turbine engine 116 includes a substantially tubular outer casing 118 that defines an annular inlet 120. Outer casing 118 encases, in a serial flow relationship, a compressor section including a booster or low pressure (LP) compressor 122 and a high pressure (HP) compressor 124; a combustion section 126; a turbine section including a high pressure (HP) turbine 128 and a low pressure (LP) turbine 130; and a jet exhaust nozzle section 132. A high pressure (HP) shaft or spool 134 drivingly connects HP turbine 128 to HP compressor 124. A low pressure (LP) shaft or spool 136 drivingly connects LP turbine 130 to LP compressor 122. Each shaft 134 and 136 is supported by a plurality of bearing assemblies 138 having a damping system 140. The compressor section, combustion section 126, turbine section, and exhaust nozzle section 132 together define an air flow path 137.

In the exemplary embodiment, fan case assembly 114 includes a fan 142 having a plurality of fan blades 144 coupled to a disk 146 in a spaced apart manner. As depicted, fan blades 144 extend outwardly from disk 146 generally along radial direction R. Fan blades 144 and disk 146 are together rotatable about longitudinal centerline 112 by LP shaft 136.

Referring still to the exemplary embodiment of FIG. 1, disk 146 is covered by rotatable front hub 148 aerodynamically contoured to promote airflow through the plurality of fan blades 144. Additionally, exemplary fan case assembly 114 includes an annular fan casing or outer nacelle 150 that circumferentially surrounds fan 142 and/or at least a portion of gas turbine engine 116. It should be appreciated that nacelle 150 may be configured to be supported relative to gas turbine engine 116 by an outlet guide vane assembly 152. Moreover, a downstream section 154 of nacelle 150 may extend over an outer portion of gas turbine engine 116 so as to define a bypass airflow passage 156 therebetween.

During operation of turbofan engine 110, a volume of air 158 enters turbofan engine 110 through an associated inlet 160 of nacelle 150 and/or fan case assembly 114. As air 158 passes across fan blades 144, a first portion of air 158 as indicated by arrows 162 is directed or routed into bypass airflow passage 156 and a second portion of air 158 as indicated by arrows 164 is directed or routed into air flow path 137, or more specifically into booster compressor 122. The ratio between first portion of air 162 and second portion of air 164 is commonly known as a bypass ratio. The pressure of second portion of air 164 is then increased as it is routed through HP compressor 124 and into combustion section 126, where it is mixed with fuel 165 supplied by a fuel system 167 and burned to provide combustion gases 166. Fuel system 167 channels fuel 165 from a fuel tank (not shown) to combustion section 126.

Combustion gases 166 are routed through HP turbine 128 where a portion of thermal and/or kinetic energy from combustion gases 166 is extracted via sequential stages of HP turbine stator vanes 168 that are coupled to outer casing 118 and HP turbine rotor blades 170 that are coupled to HP shaft or spool 134, thus causing HP shaft or spool 134 to rotate, thereby supporting operation of HP compressor 124. Combustion gases 166 are then routed through LP turbine 130 where a second portion of thermal and kinetic energy is extracted from combustion gases 166 via sequential stages of LP turbine stator vanes 172 that are coupled to outer casing 118 and LP turbine rotor blades 174 that are coupled to LP shaft or spool 136, thus causing LP shaft or spool 136 to rotate, thereby supporting operation of booster compressor 122 and/or rotation of fan 142. Combustion gases 166 are subsequently routed through jet exhaust nozzle section 132 of gas turbine engine 116 to provide propulsive thrust. Simultaneously, the pressure of first portion of air 162 is substantially increased as first portion of air 162 is routed through bypass airflow passage 156, including through outlet guide vane assembly 152 before it is exhausted from a fan nozzle exhaust section 176 of turbofan engine 110, also providing propulsive thrust. HP turbine 128, LP turbine 130, and jet exhaust nozzle section 132 at least partially define a hot gas path 178 for routing combustion gases 166 through gas turbine engine 116.

In operation, each shaft 134 and/or 136 generally rotates about longitudinal centerline 112. However, during some operating conditions, such as, but not limited to, engine start, shaft 134 and/or 136 undergoes an eccentric or orbiting motion which induces vibration and deflection that may propagate or transfer to other turbofan engine 110 locations. In the exemplary embodiment, damping system 140 includes an oil supply system 180 that circulates oil 182 through a damper (not shown) such as a squeeze film damper. Damping system 140 is provided at the bearing positions of shafts 134 and/or 136 to transfer vibratory and/or radial motion to hydrodynamic forces in oil 182 and facilitates reducing vibration and deflection loads within turbofan engine 110. In alternative embodiments, damping system 140 may be positioned at any location along rotating shafts 134 and/or 136.

It should be appreciated, however, that exemplary turbofan engine 110 depicted in FIG. 1 is by way of example only, and that in other exemplary embodiments, turbofan engine 110 may have any other suitable configuration. It should also be appreciated, that in still other exemplary embodiments, aspects of the present disclosure may be incorporated into any other suitable gas turbine engine. For example, in other exemplary embodiments, aspects of the present disclosure may be incorporated into, e.g., a turboprop engine, a military purpose engine, and a marine or land-based aero-derivative engine.

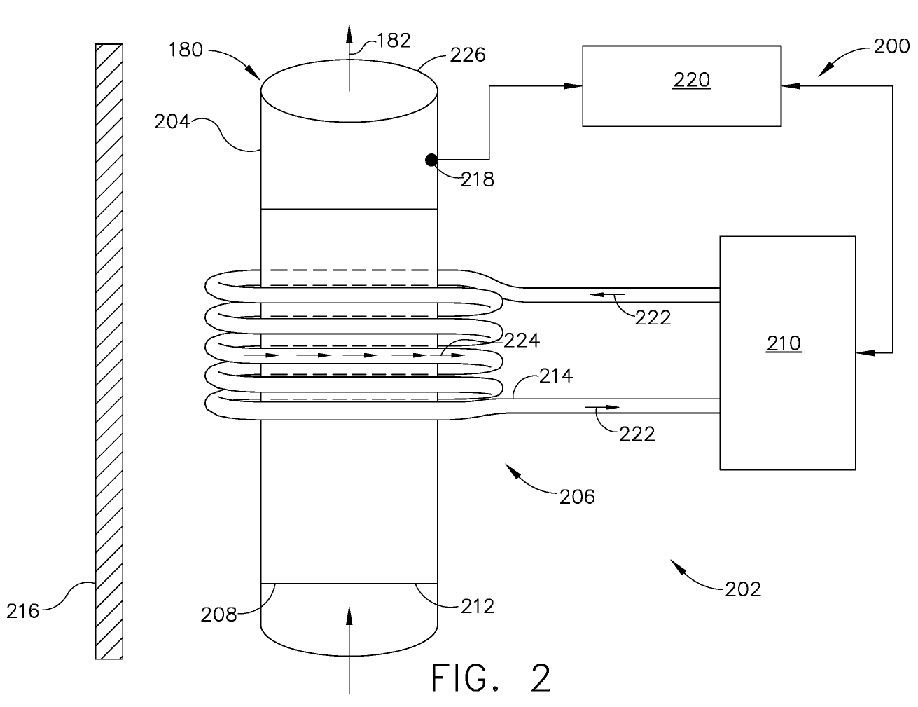

FIG. 2 is a schematic illustration of an exemplary fluid viscosity system 200 from turbofan engine 110 (shown in FIG. 1). In the exemplary embodiment, oil supply system 180 includes fluid viscosity system 200 that facilitates reducing oil viscosity 182 that is channeled to the squeeze film damper of damping system 140 (shown in FIG. 1). Fluid viscosity system 200 includes an induction assembly 202 coupled to a fluid line 204 which is positioned within turbofan engine 110. Induction assembly 202 includes an electromagnet 206 defined within at least a portion 208 of fluid line 204. Induction assembly 202 further includes an electronic oscillator 210 electronically coupled to electromagnet 206. Specifically, electromagnet 206 includes a metallic fluid line section 212 and an inductor coil 214 that is extended around metallic fluid line section 212 a predetermined number of times and coupled to electronic oscillator 210.

Fluid viscosity system 200 further includes an electromagnetic shield 216 at least partially surrounding induction assembly 202. Additionally, a temperature/viscosity sensor 218 is coupled in flow communication with fluid line 204 and is operatively coupled to a controller 220. Controller 220 is further operatively coupled to electronic oscillator 210. In the exemplary embodiment, temperature sensor 218 is positioned downstream of induction assembly 202. In alternative embodiments, temperature sensor 218 may be positioned at any other location that enables fluid viscosity system 200 to function as described herein.

During operation of turbofan engine 110, for example during engine start conditions, oil 182 may be at a lower temperature such that oil 182 is highly viscous and more resistant to shear and/or tensile stress within damping system 140. Fluid viscosity system 200 facilitates increasing the temperature of oil 182 and reducing viscosity of oil 182, such that when oil 182 is channeled through damping system 140 vibration and radial motion of rotor shaft 134 and/or 136 is reduced. Specifically, fluid viscosity system 200 heats oil 182 through induction heating to a predetermined temperature and viscosity. Electronic oscillator 210 generates and transmits a high-frequency alternating current (AC) 222 at a predetermined frequency and magnitude through electromagnet 206. The rapidly alternating magnetic field penetrates metallic fluid line section 212 generating eddy currents 224 therein. Eddy currents 224 flowing through electrical resistance of metallic fluid line section 212 heats metallic fluid line section 212 by Joule/resistance heating which causes oil 182 within to increase in temperature and reduce viscosity. In alternative embodiments, induction heat may be generated by magnetic hysteresis losses. In yet other embodiments, induction heat may be generated by series-resonance electromagnetism. Alternatively or additionally, fluid viscosity system 200 may include any other heating system that enables fluid within a fluid line to be heated and reduces viscosity. For example, fluid viscosity system 200 may include an electrical conduction assembly.

In some embodiments, temperature sensor 218 measures the temperature of oil 182 which is received by controller 220. Controller 220 controls electronic oscillator 210, for example, by setting the frequency and magnitude of AC 222 of electronic oscillator 210 based on temperature and flow rate of oil 182. In alternative embodiments, controller 220 may control electronic oscillator 210 by use of one or more of ambient temperature measurements, engine operation time, engine shutoff time, and others. Furthermore, controller 220 turns fluid viscosity system 200 on/off such that fluid viscosity system 200 is operable only when fluid heating and viscosity reduction is needed. In alternative embodiments, controller 220 may be included within a full authority digital engine (or electronics) control (FADEC).

In the exemplary embodiment, oil 182 is inductively heated to a minimum temperature of 50° Fahrenheit (10° Celsius) to reduce viscosity thereof. In alternative embodiments, oil 182 is heated to any other temperature that reduces viscosity and enables damping system 140 to function as described herein. Additionally or alternatively, temperature sensor 218 may be a viscosity sensor or a process sensor that measures/calculates the viscosity of oil 182 such that fluid viscosity system 200 receives viscosity measurements to control the viscosity of oil 182 through the system. In other embodiments, electromagnetic shield 216 at least partially surrounds induction assembly 202 such that electronic interference with other electrical turbofan engine 110 components is reduced.

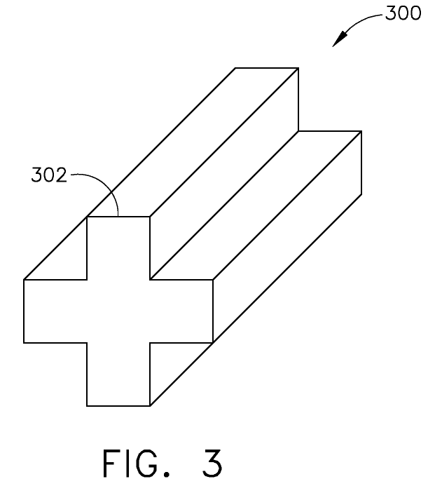

In the exemplary embodiment, a portion of fluid line 204 includes metallic fluid line section 212 such that electromagnet 206 can be formed therein. Metallic fluid line section 212 is any material that has good electrical and thermal conductivity, for example, and not by way of limitation, iron, nickel, and copper. Furthermore, in the exemplary embodiment, fluid line 204, including metallic fluid line section 212, has a generally circular shaped cross-sectional profile with a perimeter length 226 wrapped with inductor coil 214. In some embodiments, metallic fluid line section 212 is sized to further facilitate induction heating as discussed below in reference to FIG. 3. In other embodiments, metallic fluid line section 212 is S-shaped within inductor coil 214 such that oil 182 flowing therein makes multiple passes through inductor coil 214. By heating oil 182 within metallic fluid line section 212, fluid viscosity system 200 may be positioned anywhere along fluid line 204. Furthermore, energy consumption is reduced because the heated oil 182 is channeled directly to damper assembly 140.

FIG. 3 is a perspective view of an exemplary metallic fluid line section 300 that may be used with fluid viscosity system 200 (shown in FIG. 2). In this alternative embodiment, metallic fluid line section 300 has a generally cross shaped cross-sectional profile with a perimeter length 302 that is wrapped with inductor coil 214 (shown in FIG. 2). As compared with metallic fluid line section 212 with perimeter length 226 (shown in FIG. 2), perimeter length 302 is greater than perimeter length 226. The increased length of perimeter length 302 further facilitates induction heating efficiency because the flow of oil 182 therethrough has greater surface contact with metallic fluid line section 300 increasing induction heating thereof. In alternative embodiments, metallic fluid line section 300 may have any other shape that increases fluid contact with induction assembly 202.

In reference to FIGS. 2 and 3, fluid viscosity system 200 has been discussed with respect to oil supply system 180 for damping system 140. It should be appreciated, however, that fluid viscosity system 200 may facilitate induction heating of any other fluid within turbofan engine 110 (shown in FIG. 1). For example, in an alternative embodiment, fluid viscosity system 200 may be coupled to fuel supply system 167 (shown in FIG. 1) to facilitate induction heating of fuel 165 (also shown in FIG. 1). During cold ambient temperatures, ice particles may form within fuel 165, as such, fluid viscosity system 200 inductively heats fuel 165 reducing ice particles therein.

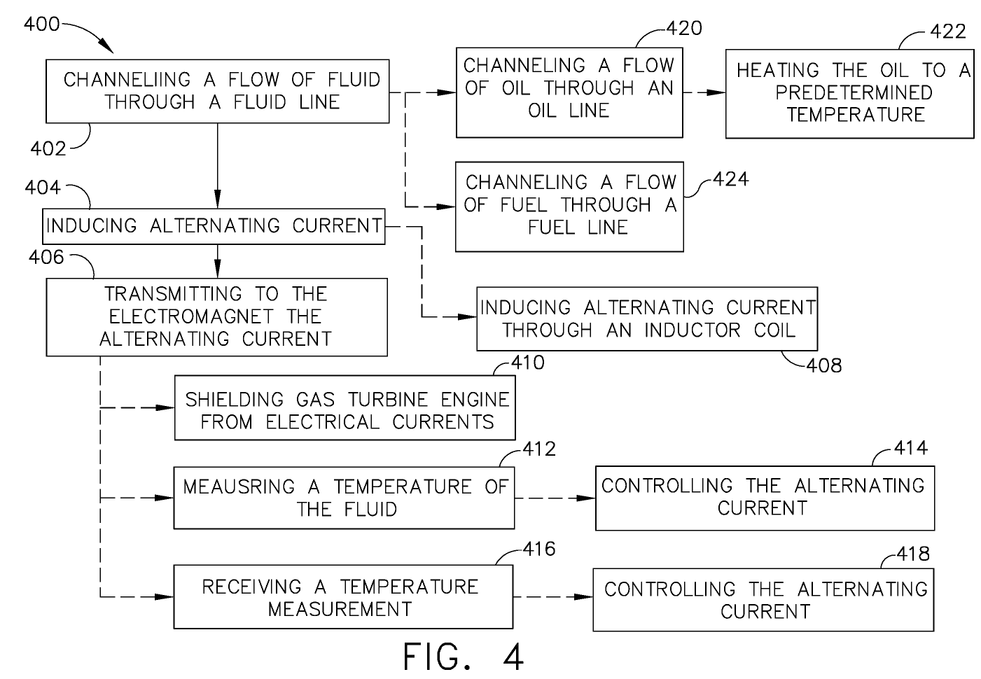

FIG. 4 is a flow diagram of an exemplary embodiment of a method 400 for heating fluid with a fluid viscosity system, such as fluid viscosity system 200 (shown in FIG. 2), in a gas turbine engine, such as turbofan engine 110 (shown in FIG. 1). With reference also to FIGS. 1-3, the fluid viscosity system includes an induction assembly, such as induction assembly 202, coupled to a fluid line, such as fluid line 204. The induction assembly includes an electromagnet, such as electromagnet 206, and an electronic oscillator, such as electronic oscillator 210, electronically coupled to the electromagnet. Exemplary method 400 includes channeling 402 a flow, such as oil flow 182, through the fluid line. Inducing 404 an alternating current, such as AC 222, by the electronic oscillator. Method 400 further includes transmitting 406 to the electromagnet the AC at a predetermined frequency and magnitude such that a viscosity of the fluid channeled through the fluid line is reduced at least partially due to induction heating.

In some embodiments, inducing 404 the alternating current further includes inducing 408 the alternating current through an inductor coil, such as inductor coil 214, wherein the electromagnet includes a metallic fluid line section, such as metallic fluid line section 212, including at least a portion of the fluid line and an inductor coil coupled to the electronic oscillator and extended around the metallic fluid line section. In other embodiments, method 400 further includes shielding 410 the gas turbine engine from electrical currents generated by the induction assembly by an electromagnetic shield, such as electromagnetic shield 216 that at least partially surround the induction assembly.

In certain embodiments, method 400 further includes measuring 412 a temperature of the fluid channeled through the fluid line by a temperature sensor, such as temperature sensor 218, coupled in flow communication with the fluid line, and controlling 414 the alternating current based on the temperature measurement. In some embodiments, method 400 further includes receiving 416 a temperature measurement of the fluid channeled through the fluid line, and controlling 418 the alternating current based on the temperature measurement.

In other embodiments, channeling 402 the flow of fluid through the fluid line further includes channeling 420 a flow of oil through an oil line. Additionally, method 400 further includes heating 422 the oil to a predetermined temperature, such as 50° Fahrenheit. In some embodiments, channeling 402 the flow of fluid through the fluid line further includes channeling 424 a flow of fuel through a fuel line.

The above-described embodiments of a fluid viscosity system provide a system and method that facilitates heating gas turbine engine fluids within a gas turbine engine. Specifically, the fluid viscosity system includes an induction assembly coupled to a fluid line which applies an AC at a predetermined frequency and magnitude such that a fluid channeled through the fluid line is heated to a predetermined temperature through induction heating reducing viscosity thereof. In some embodiments, a temperature sensor is coupled in flow communication with the fluid line such that a temperature of the fluid channeled through the fluid line is measured for controlling the AC generated by the induction assembly. By heating the within the fluid line and reducing viscosity, the fluid viscosity system may be placed anywhere along the fluid line while also increasing control over the fluid temperature. Additionally, only the fluid that is directly channeled to a gas turbine engine component, such as a damper, is heated, thereby increasing efficiency of the fluid viscosity system and reducing energy consumption. The fluid viscosity system further decreases engine weight such that overall engine efficiency is increased.

An exemplary technical effect of the methods, systems, and apparatus described herein includes at least one of: (a) reducing oil viscosity channeled towards a damping system, increasing damping during cold engine starts and decreasing rotordynamic instability; (b) heating fuel channeled towards a combustion assembly, decreasing ice particles therein in cold ambient conditions; (c) decreasing energy requirements of a fluid viscosity system in a gas turbine engine; and (d) decreasing weight of fluid viscosity system and increasing engine efficiency.

Exemplary embodiments of methods, systems, and apparatus for the fluid viscosity system are not limited to the specific embodiments described herein, but rather, components of the systems and/or steps of the methods may be utilized independently and separately from other components and/or steps described herein. For example, the methods may also be used in combination with other systems requiring reduced fluid viscosity, and the associated methods, and are not limited to practice with only the systems and methods as described herein. Rather, the exemplary embodiment can be implemented and utilized in connection with many other applications, equipment, and systems that may benefit from fluid heating.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fluid viscosity system for use in a gas turbine engine; said fluid viscosity system comprising:
an induction assembly coupled to a fluid line within the gas turbine engine, said induction assembly comprising:
an electromagnet; and
an electronic oscillator electronically coupled to said electromagnet, said electronic oscillator configured to generate an alternating current (AC) that is transmitted to said electromagnet at a predetermined frequency and magnitude such that a viscosity of a fluid channeled through said fluid line is reduced at least partially due to induction heating.

2. The fluid viscosity system in accordance with claim 1, wherein said electromagnet comprises:
a metallic fluid line section comprising at least a portion of said fluid line; and
an inductor coil extending around said metallic fluid line section and coupled to said electronic oscillator.

3. The fluid viscosity system in accordance with claim 1 further comprising an electromagnetic shield at least partially surrounding said induction assembly.

4. The fluid viscosity system in accordance with claim 1 further comprising a temperature sensor coupled in flow communication with said fluid line and configured to measure a temperature of the fluid channeled therethrough, wherein said electronic oscillator controls the AC through said electromagnet based on a temperature measurement.

5. The fluid viscosity system in accordance with claim 1 further comprising a controller operatively coupled to said electronic oscillator, said controller configured to receive a temperature measurement of the fluid channeled through said fluid line and control the AC from said electronic oscillator based on the temperature measurement.

6. The fluid viscosity system in accordance with claim 1, wherein said fluid line comprises an oil line.

7. The fluid viscosity system in accordance with claim 6, wherein said electronic oscillator heats an oil channeled through said oil line to a predetermined temperature.

8. The fluid viscosity system in accordance with claim 1, wherein said fluid line comprises a fuel line.

9. The fluid viscosity system in accordance with claim 1, wherein said fluid line comprises a first section comprising a cross-sectional profile defined by a perimeter length and a second section comprising a cross-sectional profile defined by a perimeter length, wherein said first section perimeter length is substantially not equal to said second section perimeter length.

10. A gas turbine engine comprising:
a damping system;
a fluid line coupled in flow communication to said damping system and configured to channel an oil through said fluid line to said damping system; and
a fluid viscosity system comprising an induction assembly coupled to said fluid line, said induction assembly comprising:
an electromagnet coupled to said fluid line; and
an electronic oscillator electronically coupled to said electromagnet, said electronic oscillator configured to generate an alternating current (AC) that is transmitted to said electromagnet at a predetermined frequency and magnitude such that a viscosity of the oil channeled through said fluid line is reduced at least partially due to induction heating.

11. The gas turbine engine in accordance with claim 10, wherein said electromagnet comprises:
a metallic fluid line section comprising at least a portion of said fluid line; and
an inductor coil extending around said metallic fluid line section and coupled to said electronic oscillator.

12. The gas turbine engine in accordance with claim 10 further comprising:
a temperature sensor coupled in flow communication with said fluid line and configured to measure a temperature of the oil channeled therethrough; and
a controller operatively coupled to said electronic oscillator and said temperature sensor, said controller configured to receive the temperature measurement of the oil channeled through said fluid line and control the AC from said electronic oscillator based on the temperature measurement.

13. A method for reducing fluid viscosity with a fluid viscosity system in a gas turbine engine, the fluid viscosity system includes an induction assembly coupled to a fluid line, the induction assembly includes an electromagnet and an electronic oscillator electronically coupled to the electromagnet, said method comprising:
channeling a flow of fluid through the fluid line;
inducing an alternating current (AC) by the electronic oscillator; and
transmitting to the electromagnet the AC at a predetermined frequency and magnitude such that a viscosity of the fluid channeled through the fluid line is reduced at least partially due to induction heating.

14. The method in accordance with claim 13, wherein the electromagnet includes a metallic fluid line section including at least a portion of the fluid line and an inductor coil extending around the metallic fluid line section, the inductor coil is coupled to the electronic oscillator, said inducing the AC further comprises inducing the AC through the inductor coil.

15. The method in accordance with claim 13 further comprising shielding the gas turbine engine from electrical currents generated by the induction assembly by an electromagnetic shield that at least partially surrounds the induction assembly.

16. The method in accordance with claim 13 further comprising:
measuring a temperature of the fluid channeled through the fluid line by a temperature sensor coupled in flow communication with the fluid line; and
controlling the AC based on the temperature measurement.

17. The method in accordance with claim 13, wherein a controller is operatively coupled to the electronic oscillator, said method further comprising:
receiving a temperature measurement of the fluid channeled through the fluid line; and
controlling the AC based on the temperature measurement.

18. The method in accordance with claim 13, wherein said channeling a flow of fluid though a fluid line further comprises channeling a flow of oil through an oil line.

19. The method in accordance with claim 18 further comprising heating the oil to a predetermined temperature.

20. The method in accordance with claim 13, wherein said channeling a flow of fluid though a fluid line further comprises channeling a flow of fuel through a fuel line.
